(19) United States
(12) Patent Application Publication
(10) Pub. No.: US 2006/0200590 A1
(43) Pub. Date: Sep. 7, 2006

(54) System and method for managing optical drive features

(76) Inventor: David M. Pereira, Austin, TX (US)

Correspondence Address: HAMILTON & TERRILE, LLP, P.O. BOX 203518, AUSTIN, TX, 78720, US

(21) Appl. No.: 11/071,093

(22) Filed: Mar. 3, 2005

(51) Int. Cl. G06F 3/00

(52) U.S. Cl. 710/8

(57) ABSTRACT

Information handling system component feature sets are selectively enabled or disabled with a feature set table for improved flexibility in the manufacturing of information handling systems with desired features. For example, an optical disc drive has plural features loaded in firmware, such as reading and writing formats for plural types of optical media. A feature set table in firmware identifies the status of the features as enabled, disabled, locked or unlocked. A feature set modifier associated with the optical disc drive enables features having the enabled status to be available for use and disables features having the disabled status to be unavailable for use. Disabled features that have an unlocked status are available for upgrade to enabled status by modification to the feature set table while features with a locked status are prohibited from an upgrade to enabled status.

### BACKGROUND OF THE INVENTION

1. Field of the Invention

The present invention relates in general to the field of information handling system components, and more particularly to a system and method for managing optical drive features.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling system versatility to perform a wide variety of tasks with cost efficiency is provided in part by the wide variety of components available for manufacture of information handling systems. In a build-to-order manufacturing system, a customer selects a configuration of hardware and software components to build an information handling system having desired capabilities and costs. For instance, the speed of the central processing unit (CPU), the size and speed of memory devices, and the quality of the display are all factors that impact the cost and performance of an information handling system. Generally, different types of components have different types of feature sets with a selected feature set impacting the cost and performance of the component. As an example, optical disc drives are typically available with a variety of feature sets that define the capability of an optical drive to read and/or write information. Optical drives commonly support multiple media types, such as Compact Disc (CD) or Digital Versatile Disc (DVD) media, by including multiple lasers, such as an infrared laser for CD media and a red laser for DVD media. Future generation optical drives will have the option of supporting High Definition DVD or Blu-ray media by including a blue laser. In addition, a variety of features are available within each of these media types, including the ability to read and write on different types of material and with different types of formats. For instance, the available types of media include writable media (CD-R, DVD-R and DVD+R) and rewritable media (CD-RW and DVD-RW).

One difficulty with the manufacturing of information handling systems is maintaining an adequate inventory of components to build systems desired by customers. Building information handling systems from a larger pool of available components increases the expense of the systems by adding inventory overhead costs and by complicating the logistics of the building process in the delivery of ordered components to the manufacturing line in a timely manner. Another difficulty is ensuring that the features included in an information handling system will have the capabilities desired by a customer. For instance, a customer who orders a DVD optical drive with a DVD+R writing feature set will have a poor experience if the customer intends to play written DVDs on a DVD player that is DVD-R compatible and not DVD+R compatible. Such misunderstandings often lead to calls by the customer for technical assistance, dissatisfaction of the customer with the system and return of the system or replacement of the optical drive. One solution to this difficulty is to include features in an information handling system even though the customer has not specifically requested the features. In the case of optical drives, the extra features are often added as firmware by the optical drive manufacturer that enables the hardware to perform desired functions. However, including unused features, such as features that require payment of a license fee, increases the cost of the system while adding little or no value for the customer.

### SUMMARY OF THE INVENTION

Therefore a need has arisen for a system and method which manages information handling system component firmware features in a flexible manner.

In accordance with the present invention, a system and method are provided which substantially reduce the disadvantages and problems associated with previous methods and systems for managing information handling system component firmware features. A feature set table lists the features available in the component and associates an enabled or disabled status with each feature. Component firmware is permitted to perform features having an enabled status and prohibited from performing features having a disabled status.

More specifically, an optical disc drive has a set of features available to run in firmware. A feature set table in firmware lists the features and associates an enabled or disabled status with each feature. A feature set module in the firmware checks the status of a feature requested by a user to allow enabled features to run and prohibit disabled features from running. The feature set table also associates a locked or unlocked status with each feature. If the feature set module receives authorized requests to update the feature set table, updates are allowed to modify the enabled status of unlocked features but not of locked features. An example of a selectively enabled feature includes enablement of various types of optical media formats for reading and writing information with various types of optical media. Another example of a selectively enabled feature is enablement of selected encryption formats, such as the CSS format for reading commercial DVD devices. Yet another example is a debug utility for checking the operation of an optical drive. Manufacturing of information handling systems with selectively enabled features allows a common firmware version to span across plural configurations of features by disabling features that are not desired or paid for.

The present invention provides a number of important technical advantages. One example of an important technical advantage is that the inventory maintained for manufacturing of an information handling system is reduced by selective enablement of features for a given hardware component. The selective enablement of features in firmware allows greater automation of the manufacturing process with orders built by a brief re-flash of a firmware feature set table rather than manual selection of a component having the selected features or re-flash to load the features. Customer satisfaction is improved since the enabled feature set can be remotely modified to provide additional features as desired in a timely and effortless manner. Manufacturing cost more directly relates to the system ordered by the customer with the addition of features for a system increasing the price accordingly. As an example, the customer who wants to have DVD-R capability added to an optical drive pays a fee to have that feature enabled that corresponds to the license fee paid by the manufacturer for that feature. As another example, a corporate customer orders systems with DVD optical drives that have a DVD movie playing disabled to ensure that employees use the system for work rather than entertainment, with the movie playing feature selectively enabled as needed for work purposes.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having an optical disc drive with selectively enabled features;

FIG. 2 depicts a functional block diagram of a process for manufacturing of an information handling system with selectively enabled features; and

FIG. 3 depicts a flow diagram of a process for selectively enabling features of an information handling system component.

### DETAILED DESCRIPTION

Selective enablement of features in firmware of an information handling system component allows modifications of the features available from the component without loading the feature in a re-flash of the firmware. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

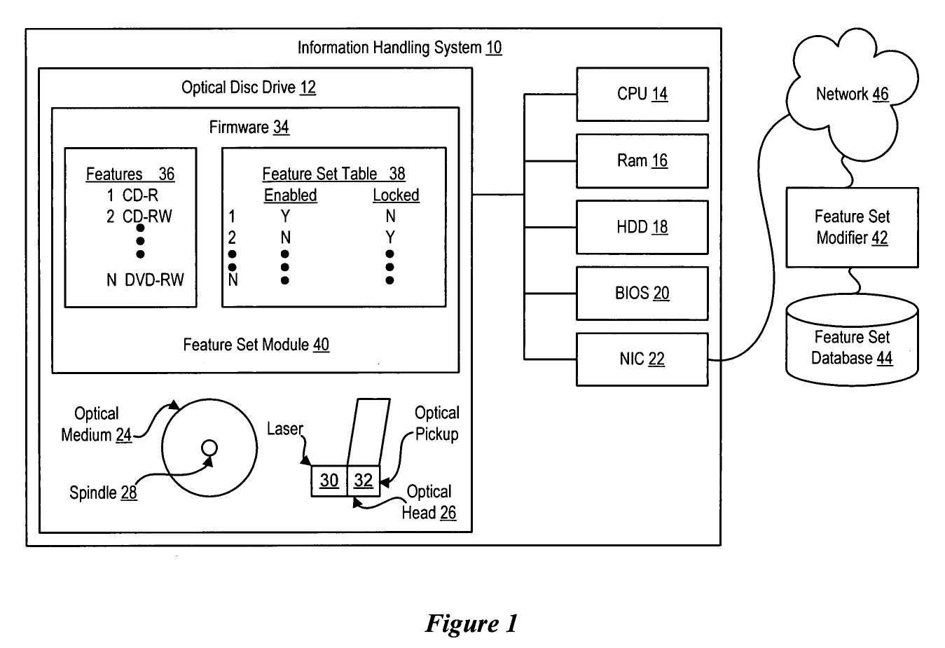

Referring now to FIG. 1, a block diagram depicts an information handling system 10 having an optical disc drive 12 with selectively enabled features. In addition to optical disc drive 12, information handling system 10 includes a number of interfaced components to process information, such as a CPU 14, RAM 16, hard disk drive 18, basic input output system 20 and network interface 22. Optical disc drive 12 interfaces with the information handling system components to read information from and write information to an optical medium 24. Optical medium 24 may be any of plural types of media compatible with optical disc drive 12. For instance, an infrared laser and pickup unit in optical head 26 allow interaction with Compact Disc (CD) media, a red laser and pickup unit allow interaction with Digital Versatile Disc (DVD) media, and a blue laser and pickup unit allow interaction with Blu-ray or High Definition DVD media. In operation, a spindle assembly 28 spins optical medium 24 proximate optical head 26 so that laser 30 provides illumination for reading and writing information, and optical pickup unit 32 detects illumination reflected from optical medium 24 for reading information. Various formats for reading and writing to optical medium 24 are managed with firmware 34. For instance, instructions in firmware 34 set laser power, spindle speed and optical head characteristics based on features 36 associated with the type of optical medium 24. As an example, an infrared laser supports CD-R media with a first feature 36 providing read/write parameters for optical head 26 and supports CD-RW media with a second feature 36 providing read/write parameters for optical head 26.

The use of features 36 by firmware 34 is managed by a feature set table 38 and a feature set module 40. Feature set table 38 holds an enabled status and a locked status for each feature 36. If a feature 36 is called by firmware 34, feature set module 40 allows firmware 34 to use the feature as long as the status of the feature is enabled. If the status of a feature is disabled, feature set module 40 prohibits firmware 34 from use of the feature. Feature set module 40 interfaces with feature set table 38 to selectively modify the status of features 36 when a change in status is authorized, such as with a password, encrypted instructions, use of optical disc drive 12's serial number or other protection scheme that prevents unauthorized modifications. For instance, a remote feature set modifier 42 having a feature set database 44 with authorization information interfaces through a network 46 to authorize changes to feature set table 38. In alternative embodiments, feature set modifier 42 is an operating system or disc drive utility. Once feature set modifier 42 authorizes an update to feature set table 38, feature set module 40 enforces the updated enable or disable status. However, in some instances, feature set table 38 has a locked status that prohibits an update to the enabled status. The locked status prevents predetermined features 36 from being updated, such as where an enabled status must be maintained or where an enabled status is never authorized. As an example, if firmware 34 is provided with an unlicensed feature, the unlicensed feature is locked to prevent its use without requiring different versions of firmware 34 for different license situations.

Selective enablement and disablement of features for an optical disc drive or other information handling system component increases the flexibility available for the firmware version loaded on the component without a re-flash of the features in the firmware. One example of selective enablement of features is enablement of one optical media format, such as DVD-R, and disablement of a related optical media format, such as DVD+R, in order to provide a writeable DVD capability selected by a consumer without paying license fees for both formats even though both formats are in the firmware. A consumer who subsequently wishes to have both capabilities can update the optical disc drive feature set table for payment of the license fee. Another example of selective enablement of a feature is selective enablement of the capability to play commercially available CSS-encrypted video discs. A business could thus prevent the optical disc drive from use as an entertainment device. Alternatively, limited use of a feature on a pay-per-use basis manages viewing of restricted material, such as a movie rented for one viewing. Yet another example of selective enablement of a feature is a component “debug” feature that is selectively enabled to confirm proper operation of the component and then disabled to restore normal component operation.

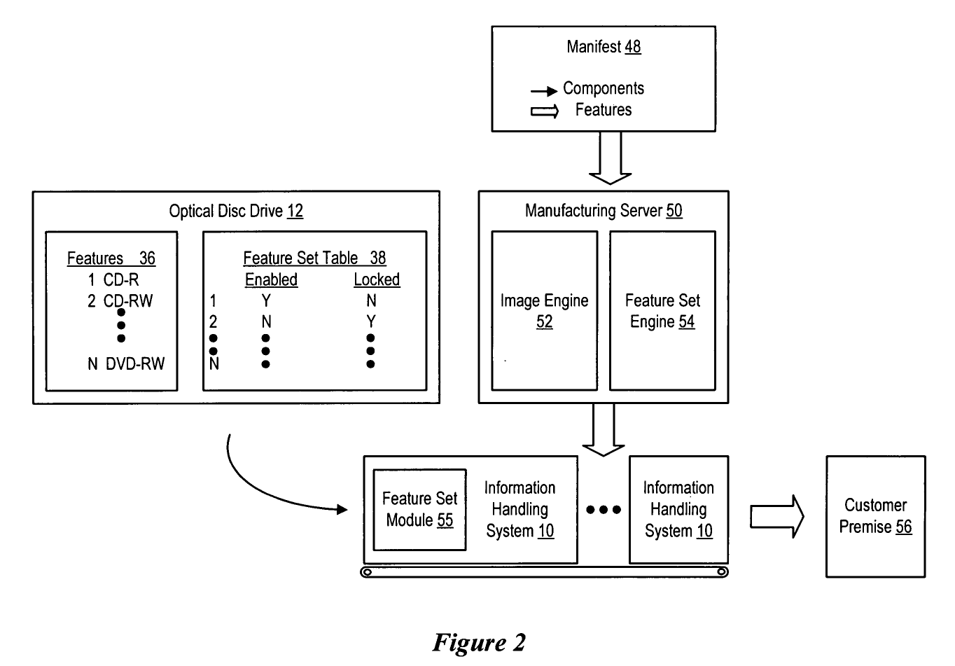

Referring now to FIG. 2, a functional block diagram depicts a process for manufacturing of an information handling system with selectively enabled features to improve manufacturing efficiency. Optical drive 12 is delivered to the information handling system manufacturer with a complete set of fully developed and tested features in firmware. A manifest 48 defines the components and features of an information handling system 10 in the manufacturing process. A manufacturing server 50 has an image engine 52 that copies a software image onto information handling system 10 according to manifest 48 and a feature set engine 54 that defines the status of features in feature set table 38. Feature set engine 54 reads the features 36 and their status and sends a feature set modification command to update the status to that of manifest 48, including locking features that are prohibited from use. A feature set module 55 running on information handling system 10 applies the modification command of feature set engine 54 to conform feature set table 38 with the features enabled and disabled by manifest 48. In this manner, the same firmware version is adapted by the manufacturer to fulfill a variety of feature sets without having to re-flash the firmware to add or remove features. Information handling system 10 is then delivered to customer premise 56 where a customer may selectively enable unlocked features as authorized, such as by payment of a license fee.

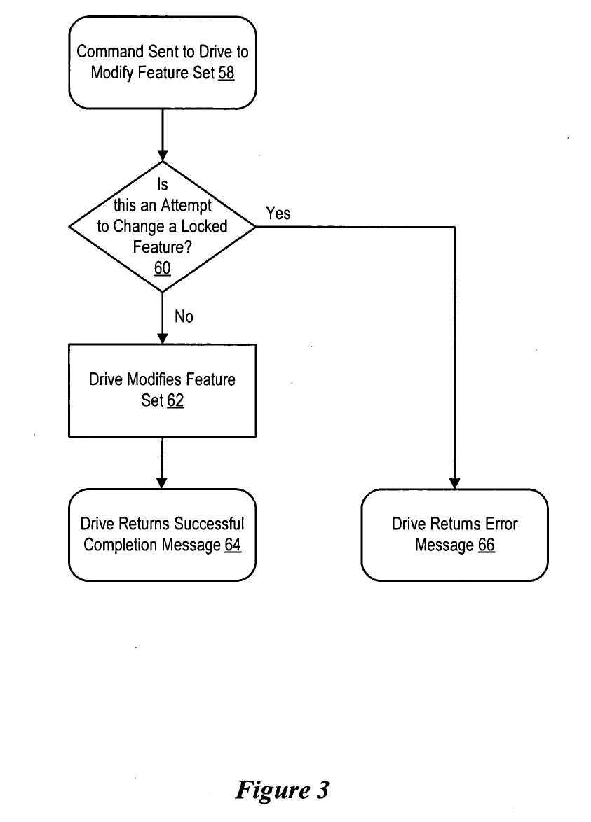

Referring now to FIG. 3, a flow diagram depicts a process for selectively enabling or disabling features of an information handling system component. At step 58, a command is sent to an optical drive or other component to modify the feature set. The feature set modification command originates from an authorized source, such as a utility running on an information handling system or a remote network location interfaced with the information handling system. At step 60, a determination is made of whether the command attempts to modify a locked feature that is prohibited from modification. If the feature is not locked the process continues at step 62 with modification of the feature set in accordance with the command and ends at step 64 with return by the component of a success message. If the feature is locked at step 60 then modification of the feature set is prohibited and the process ends at step 66 with an error message sent to indicate that the feature set modification command was not executed.

Although the present invention has been described in detail, it should be understood that various changes, substitutions and alterations can be made hereto without departing from the spirit and scope of the invention as defined by the appended claims.

What is claimed is:

1. An information handling system comprising:
a central processing unit operable to process information;
memory interfaced with the central processing unit and operable to store information;
a component interfaced with the central processing unit, the component operable to perform plural features, the component having firmware, the features performed at least in part with the firmware;
a feature set table associated with the component, the feature set table having the plural features, each feature further associated with an enabled or disabled status; and
a feature set modifier associated with the component and operable to enable features of the component having an enabled status and to disable features of the component having a disabled status.

2. The information handling system of claim 1 wherein each feature of the feature set table further has a locked or unlocked status, the feature set modifier further operable to prohibit an enabled status of a feature with a locked status of that feature.

3. The information handling system of claim 1 wherein the component comprises an optical disc drive and the features comprise plural sets of instructions for writing information, each set of instructions associated with one of plural optical media.

4. The information handling system of claim 1 wherein the component comprises an optical disc drive and the features comprise a set of instructions for reading an optical medium having information of a predetermined format, the optical disc drive operable to read the optical medium if the feature is enabled and not operable to read the optical medium if the feature is disable.

5. The information handling system of claim 4 wherein the predetermined format is a commercially encrypted movie disc.

6. An optical disc drive comprising:
a spindle assembly operable to spin an optical medium;
an optical head proximate the optical medium and having at least one laser and at least one optical pickup unit, the laser operable to illuminate the optical medium to read and write information, the optical pickup unit operable to receive reflections of the laser to read information;
firmware interfaced with the optical head and having plural sets of instructions, each set of instructions associated with one or more features; and
a feature set table associated with the firmware operable to identify enabled features that the firmware is permitted to perform and disabled features that the firmware is prohibited to perform.

7. The optical disc drive of claim 6 wherein the plural sets of instructions comprise instructions for writing information in plural optical media formats, the feature set table defining the permitted optical media types and prohibited optical media types.

8. The optical disc drive of claim 7 wherein the permitted optical media comprises DVD+R and the prohibited optical media comprises DVD-R.

9. The optical disc drive of claim 6 wherein the plural sets of instructions comprise instructions for reading information in plural optical media formats, the feature set table defining the permitted optical media formats and prohibited optical media formats.

10. The optical disc drive of claim 9 wherein the prohibited optical media formats comprise CSS-encryption.

11. The optical disc drive of claim 6 wherein the features comprise a debug module operable to diagnose difficulties with the optical disc drive.

12. A method for selecting features of an information handling system component, the method comprising:
storing plural sets of instructions in firmware of the component, each set of instructions associated with one or more features;
storing a feature set table in the firmware of the component, the feature set table having the plural features, each feature having a status of enabled or disabled;
enabling the firmware to perform features having an enabled status; and
disabling the firmware to perform features having a disabled status.

13. The method of claim 12 further comprising:
revising the feature set table to change the status associated with a feature from a disabled to an enabled status; and
enabling the firmware to perform the revised feature.

14. The method of claim 13 further comprising:
coordinating authorization for revising the feature set table from a remote network location.

15. The method of claim 14 wherein the component is an optical disc drive and the features comprise plural optical media formats.

16. A method for manufacturing of an information handling system, the method comprising:
assembling plural components into an information handling system configured to process information, at least one component having plural features stored in firmware;
selectively enabling one or more of the features; and
selectively disabling one or more of features, the disabled features remaining stored in the firmware.

17. The method of claim 16 wherein the component having plural features comprises an optical disc drive and the features comprise plural optical media formats for reading or writing information.

18. The method of claim 16 further comprising:
shipping the information handling system to a customer premise; and
revising the component at the customer premise to enable a disabled feature.

19. The method of claim 18 wherein the component having plural features is an optical disc drive and revising the firmware further comprises enabling the playing of encrypted movie information.

20. The method of claim 18 wherein the component having plural features is an optical disc drive, the method further comprising:
locking one or more features to prohibit enabling of the one or more features at the customer premise.

21. The method of claim 16 further comprising:
shipping the information handling system to a customer premise; and
revising the component at the customer premise to disable an enabled feature.
